(19) United States
(12) Patent Application Publication
(10) Pub. No.: US 2008/0130428 A1
(43) Pub. Date: Jun. 5, 2008

(54) WOBBLE SIGNAL DETECTION CIRCUIT AND WOBBLE SIGNAL DETECTION METHOD

(75) Inventor: Satoru Kojima, Kawajuchi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/941,036

(22) Filed: Nov. 15, 2007

(30) Foreign Application Priority Data
Nov. 30, 2006 (JP) 2006-325019

(51) Int. Cl. G11B 7/00

(52) U.S. Cl. 369/44.13

(57) ABSTRACT

According to one embodiment, a wobble signal detection circuit comprises a phase control unit configured to read out a phase-modulated wobble signal from an optical disk and control a phase of the wobble signal to be coincide with a phase of a reference signal, a calculating unit configured to calculate a first correlation value showing an integration result between a phase controlled wobble signal which is controlled by the phase control unit and the reference signal, and a second correlation value showing an integration result between the phase controlled wobble signal and a phase-inverted signal of the reference signal, and a polarity determining unit configured to determine a polarity of the phase controlled wobble signal based on the first and the second correlation value.

### CROSS-REFERENCE TO RELATED APPLICATIONS

This application is based upon and claims the benefit of priority from Japanese Patent Application No. 2006-325019, filed Nov. 30, 2006, the entire contents of which are incorporated herein by reference.

### BACKGROUND OF THE INVENTION

1. Field of the Invention

One embodiment of the present invention relates to a wobble signal detection circuit and a wobble signal detection method for use in, for example, an optical disk device.

2. Description of the Related Art

An optical disk such as a digital versatile disk (DVD) as a digital recording medium has gained much popularity, and high reliability has been desired for an optical disk device to reproduce such optical disk. Meanwhile, the standardization itself of the DVD has evolved, and a high density (HD) DVD standard corresponding to high-definition television (High Resolution Digital Television) has also become completed. In the HD DVD standard, since a recording density becomes higher than a current DVD standard, a CN ratio of a reproduced signal is apt to be reduced, and extracting a synchronous signal and address information from the reproduced signal becomes relatively easy to be affected by disturbance of noise etc.

In a DVD+R or an HD DVD standard optical disk for recording, grooves to guide a laser beam for recording are formed in a spiral shape, and the grooves are slightly wobbled in a radius direction at a fixed frequency (wobble frequency). A reference signal (reference clock) to control rotations of a motor for disk rotation is generated from the wobble frequency. Address information is superimposed onto a wobble signal by means of phase modulation. More specifically, address information is recorded so as to indicate “0” and “1” by inverting the phase of the wobble signal, the wobble signal from a reflection beam of the laser beam from the optical disk is detected, and the address information is obtained by demodulating the “0” and “1” from the wobble signal. In synchronous-detecting the wobble signal recorded in such phase modulation system, there is some possibility that deterioration and phase inversion of the wobble signal are generated caused by cross talk from the adjacent wobble signals and that the precision of synchronous detection is deteriorated and wobble information cannot be accurately demodulated. A wobble information detection method and wobble information detection device of an optical recording medium to solve this problem is disclosed (Jpn Pat. Appln. KOKAI Publication No. 2004-318939). In the device described in this document, phase integral periods are preliminarily set for each unit data section in a reference wobble section and a data wobble string by detecting a synchronous pattern and at starting phase integration in each section, a phase integral value is initialized to be set to a zero level. Phase integral values relating to reference wobbles are stored in a storage unit, the polarity of a phase integral value in each unit data section is compared with the polarity of a phase integral value of the reference wobble, and it is confirmed whether the polarities are the same or reverse to determine binary information of each unit data section. Since the determination is made on the basis of polarity comparison of the phase integral values, it is hard to be affected by distortion and phase inversion of wobble signals caused by deterioration of the optical recording medium and crosstalk between adjacent tracks and this determination makes it possible to correctly and stably detect recorded information of a data wobble string.

However, in detecting the wobble signal, it is needed to match the phases of the wobble signal and the reference signal by means of phase-locked loop (PLL) control, but PLL lock is performed in a state of mismatching of the phases sometimes. For example, the polarity of an input signal (wobble signal) varies depending on the specification of a pick up, the specification of an optical disk (including disk in violation of standard), and the position where a laser beam is positioned in a land/group track in the case of land/group recording. If a wobble signal with an inverted polarity is input, a phase to be PLL-locked sometimes deviates. In some cases, the wobble information detection device cannot correctly detect a synchronous signal and a physical address.

However, since the device described in the document does not determine whether or not the device is locked in a state in which the phases do not match with each other, there is some possibility of making a mistake in determining the polarity of a signal at a phase changing point as is mentioned above.

### SUMMARY OF THE INVENTION

### BRIEF DESCRIPTION OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A and 1B are exemplary views showing an addressing method of an optical disk in an embodiment of the present invention;

FIG. 2 is an exemplary view showing a physical address format of an HD DVD-R standard;

FIG. 3 is an exemplary view showing a physical address format of an HD DVD-RAM standard;

FIG. 4 is an exemplary view showing an example of an optical disk device in the embodiment of the invention;

FIG. 5 is an exemplary view showing an example of a pick up of the optical disk device in the embodiment of the invention;

FIG. 6 is an exemplary view showing an example of a wobble PLL unit/address detection unit of the optical disk device in the embodiment of the invention;

FIG. 7 is an exemplary view showing an example of a polarity determining unit of the wobble PLL unit/address detection unit of the optical disk device in the embodiment of the invention;

FIG. 8 is an exemplary view showing an example of a synchronous signal (hereinafter referred to as SYNC)/address detection unit of the optical disk device in the embodiment of the invention;

FIG. 9 is an exemplary view showing is an example of a flywheel counter unit of the optical disk device in the embodiment of the invention;

FIGS. 10A, 10B, and 10C are exemplary views showing a sine correlation detection in the case of absence of phase deviation in the embodiment of the invention;

FIGS. 11A, 11B, 11C, 11D, and 11E are exemplary views showing a sine correlation detection in the case of presence of the phase deviation in the embodiment of the invention;

FIGS. 12A, 12B, 12C, 12D, 12E, 12F, 12G, 12H, 12I, and 12J are exemplary views showing operations in the case in which a normal polarity wobble signal has been input in a polarity determining unit in the embodiment of the invention; and

FIGS. 13A, 13B, 13C, 13D, 13E, 13F, 13G, 13H, 13I, 13J, 13K, 13L, 13M, 13N, 130, and 13P are exemplary views showing operations in the case in which an inverted polarity wobble signal has been input in the polarity determining unit in the embodiment of the invention.

### DETAILED DESCRIPTION OF THE PREFERRED EMBODIMENT

Various embodiments according to the invention will be described hereinafter with reference to the accompanying drawings. In general, according to one embodiment of the invention, a wobble signal detection circuit, comprises a phase control unit configured to read out a phase-modulated wobble signal from an optical disk and control a phase of the wobble signal to be coincide with a phase of a reference signal; a calculating unit configured to calculate a first correlation value showing an integration result between a phase controlled wobble signal which is controlled by the phase control unit and the reference signal, and a second correlation value showing an integration result between the phase controlled wobble signal and a phase-inverted signal of the reference signal; and a polarity determining unit configured to determine a polarity of the phase controlled wobble signal based on the first and the second correlation value.

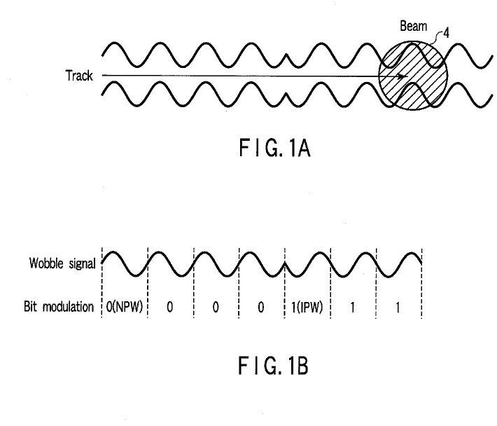

FIGS. 1A and 1B are views depicting relations between wobble and a signal in applying wobble modulation to a recording track as an addressing method of an optical disk recording medium. The addressing method reproduces digital data from a wobbled recording track (or, recording digital data on wobbled recording track); however the data recorded at this time is recorded at a specified position, and physical address information decided the position can be acquired by reading out and demodulating the wobble signal on the recording track. FIG. A depicts a reading beam 4 on the recording track. FIG. 1B depicts a detected wobble signal and a bit modulation rule in applying phase modulation to the wobble signal to embed the address information. The address information is recorded by using a sine wave of the wobble signal (normal phase wobble: NPW) as bit information “0”, and an inverted sine wave (inverted phase wobble: IPW) as bit information “1”.

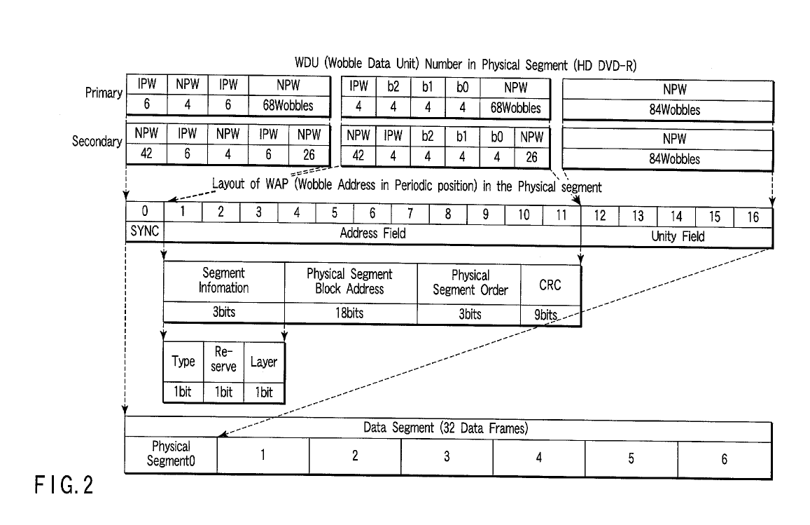

FIG. 2 depicts a physical address format of an HD DVD-R standard as an example of a phase modulation system. The format includes bit modulation data NPW (=“0”) and IPW (=“1”) of the wobble signal shown in FIG. 1B.

A physical address field includes “Segment Information” of 3 bits, “Physical Segment Block Address” of 18 bits, “Physical Segment Order” of 3 bits, and “CRC” of 9 bits and then becomes total in 33 bits. Physical address data of 33 bits in total is divided into each 3-bit, and distributed into each wobble data unit (WDU) to be embedded onto the optical recording medium through modulation processing. Accordingly, the physical address data of 33 bits is composed of 11 WDUs. Each one bit of physical address data of each WDU is, as shown in FIG. 1B, equivalent to 4 wobble. Therefore, even when whole information of 4 wobble cannot be read, if information of 1 wobble can be read, an address may be reproduced.

In the case of primary segment type, head 4 wobbles of each WDU existing ahead of the physical address data of 3 bits are composed of an IPW and are configured to easily identify the head of each WDU. Since 1 WDU is formed of 84 wobbles, 68 wobbles after the embedding of the physical address data are defined as NPW.

In the case of secondary segment type, the physical address data of 3 bits has the same configuration as that of the primary segment type; however a difference between the primary segment type and the secondary segment type resides in that NPW of 42 wobbles is arranged ahead of IPW of 4 wobbles to identify the head of each WDU, and 26 wobbles behind the embedding of the physical address data are defined as NPW.

1 address of the physical address data is configured by an assembly called a wobble address periodic position (WAP) including 17 WDUs. In each 1 WAP, a SYNC (synchronous signal) is arranged at 1 WDU of the head, a physical address is arranged at the next 11 WDUs, and non-modulation unit (unity field) is arranged in 5 WDUs behind.

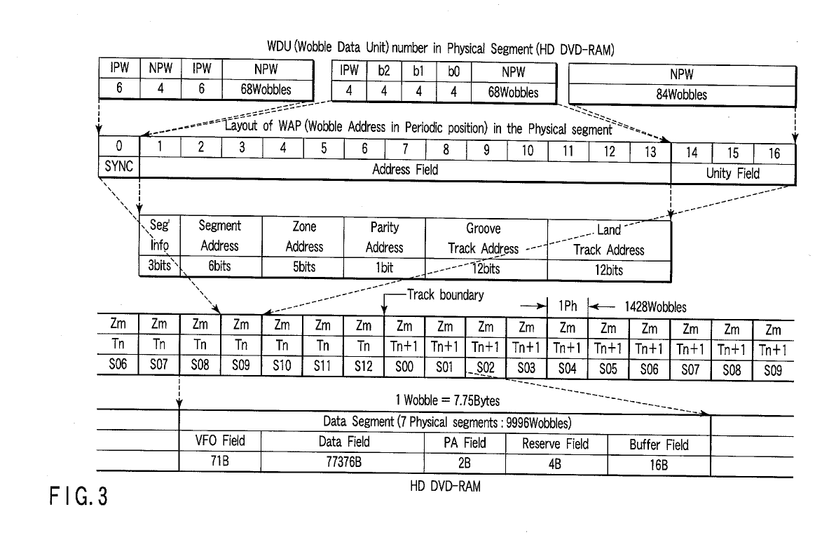

FIG. 3 shows a physical address format of an HD-DVD-RAM as another example of the phase modulation system. The format includes bit modulation data NPW (=“0”) and IPW (=“1”) shown in FIG. 1B. The physical address data include “Segment Information” of 3 bits, “Segment Address” of 6 bits, “Zone Address” of 5 bits, “Primary Address” of 1 bit, “Groove Track Address” of 12 bits, and “Land Track Address” of 12 bits, and then becomes total in 39 bits. The physical address data of 39 bits in total is divided into each 3 bits, and distributed into each WDU to be embedded on the optical disk recording medium through modulation processing. Accordingly, the physical address data of 39 bits is composed of 13 WDUs. Each 1 bit of the physical address data of each WDU is equivalent to 4 wobbles.

The head 4 wobbles existing ahead of the physical address data of 3 bits include an IPW, and configured for the head of each WDU to be easily identified. Since 1 WDU is composed of 84 wobbles, 68 wobbles behind the embedding position of the physical address data are defined as an NPW.

Information data is recorded on a recording track in which the physical addresses are embedded by means of track wobble modulation. VFO (fixed frequency signal so as to easily generate channel clock for data demodulation in reproduction operation) of 71 bytes is recorded at the front of the data of 77,376 bytes. “PA Field,” “Reserved Field,” and “Buffer Field” of total 22 bytes for data block connection processing are recorded at the rear of the data of 77,376 bytes. Total 77,469 bytes are recorded in 7 physical segments (9,996 wobbles).

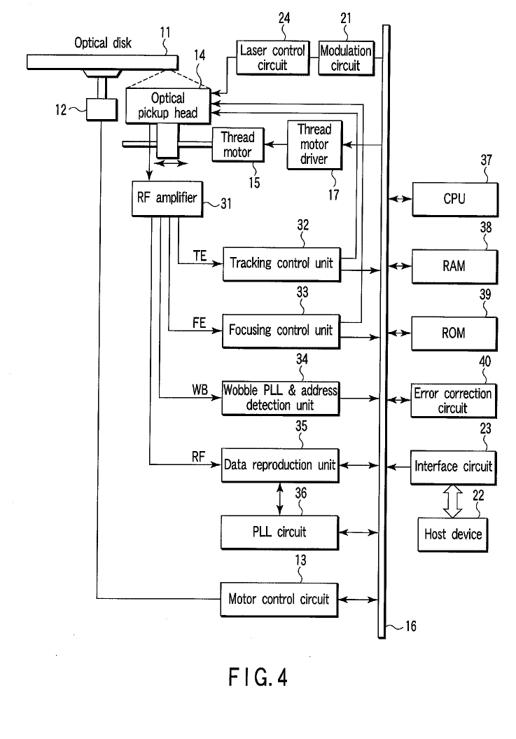

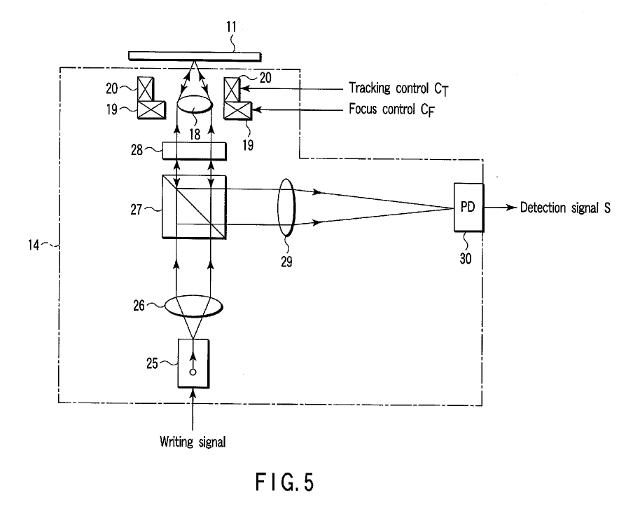

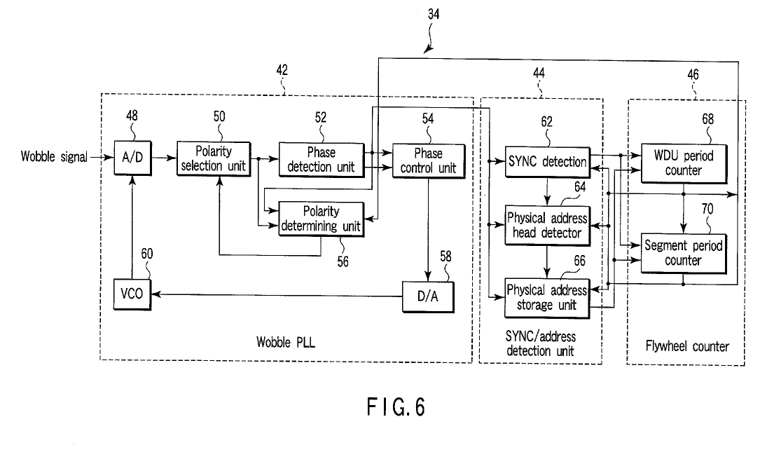

FIG. 4 is a view explaining a configuration example of the optical disk device according to the embodiment of the invention. FIG. 5 is a view explaining a configuration example of an optical pickup head 14 of the optical disk device according to the embodiment of the invention. FIG. 6 is a view explaining a configuration example of a wobble PLL & address detection unit 34 of the optical disk device according to the embodiment of the invention.

The optical disk device according to the embodiment of the invention has configurations shown in FIG. 4 and FIG. 5. Here, an optical disk 11 is explained as an optical disk of a phase modulation system capable of recording (or rewriting) user data.

As for the optical disk of the recordable or rewritable phase modulation system, for example, there is an HD DVD-RAM, an HD DVD-RW, an HD DVD-R, etc., using a blue laser beam of a wavelength about 405 nm, or a DVD+R etc. using a red laser beam of a wavelength about 650 nm.

Land track and a groove track are formed in spiral shapes on the surface of the optical disk 11. The track wobbles in a radius direction. A spindle motor 12 rotation-drives the optical disk 11. The spindle motor 12 is controlled its rotation speed by means of a motor control circuit 13.

The optical pickup head 14 records and reproduces the information to and from the optical disk 11. The pickup head 14 is coupled to a thread motor 15 via a gear. A thread motor driver 17 to be connected to a data bus 16 controls the thread motor 15. A permanent magnet (not shown) is disposed at a fixing part of the thread motor 15, when a driving coil (not shown) is excited, the pickup head 14 then moves in the radius direction of the optical disk 11.

As depicted in FIG. 5, an objective lens 18 is disposed at the pickup head 14. The objective lens 18 can move in a focusing direction (optical axis direction of lens) by driving a driving call 19, and also can move in a tracking direction (direction orthogonal to optical axis of lens) by driving a driving coil 20. The pickup head 14 then may perform track jump by moving a beam spot of a laser beam.

A modulation circuit 21 applies, for example, 8-14 modulation (EFM) to user data supplied from a host device 22 via an interface circuit 23 in recording information to generate EFM data. In recording information (in forming mark), a laser control circuit 24 supplies a writing signal to a semiconductor laser diode 25 on the basis of the EFM data supplied from the modulation circuit 21. In reading information, the laser control circuit 24 supplies a reading signal smaller than the writing signal to the laser diode 25.

The laser diode 25 generates a laser beam in response to the writing signal supplied from the control circuit 24. The laser beam generated from the laser diode 25 is irradiated onto the optical disk 11 through a collimator lens 26, a half prism 27, an optical system 28, and the objective lens 18. The reflected beam from the optical disk 11 is guided to a photo detector 30 via the objective lens 18, the optical system 28, the half prism 27 and a condenser lens 29.

The photo detector 30 includes 4-divided photo detection cells, and supplies output signals A, B, C, and D of each cell to an RF (radio frequency) amplifier 31. The RF amplifier 31 supplies a tracking error signal TE corresponding to a signal (A+D)−(B+C) to a tracking control unit 32, and a focus error signal FE corresponding to a signal (A+C)−(B+D) to a focusing control unit 33. Further, the RF amplifier 31 supplies a wobble signal WB corresponding to the signal (A+D)−(B+C) to a wobble PLL unit/Address detection unit 34, and supplies an RF signal corresponding to a signal (A+D)+(B+C) to a data reproduction unit 35.

A focus control signal C_{F} output from the focusing control unit 33 is supplied to the driving coil 19 in a focusing direction. Thereby, the focusing control unit 33 controls so that the laser beam is always just focused on a recording film of the optical disk 11. The tracking control unit 32 generates a tracking control signal C_{T} in response to the error signal TE to supply it to the drive coil 20 in the tracking direction.

Applying the focusing control and the tracking control reflects the change in reflection ratio from pits formed on a track on the optical disk in accordance with recording information to a sum signal RF of the output signal from the photo detection cells of the detector 30. The sum signal RF is supplied to the data reproduction unit 35.

The data reproduction unit 35 reproduces the recorded data, based on a reproduction clock signal from a PLL (phase locked loop) circuit 36. The reproduction unit 35 has a function to measure the amplitude of the signal RF. A CPU 37 reads out the measured value.

When the objective lens 18 is controlled by the tracking control unit 32, the thread motor 15 is controlled so as to move the objective lens 18 to the optimum position of the optical disk 11 then the pickup head 14 is controlled.

One piece of LSI chip may includes the motor control circuit 13, the laser control circuit 24, the focusing control unit 33, the tracking control unit 32, the data reproduction unit 35 and the PLL circuit 36, etc., as a servo control circuit.

These circuit units are controlled by the CPU 37 via a bus line 16. The CPU 37 controls the whole optical disk device on the basis of an operation command supplied from the host device 22 through the interface circuit 23.

Further, the CPU 37 uses a RAM 38 as a working area to perform prescribed operations in accordance with a program recorded on a ROM 39.

The data reproduced by the data reproduction unit 35 is supplied to suitable devices to reproduce a video, a sub-video, audio, etc., after being applied error correction processing by an error correction circuit 40.

FIG. 6 shows an example of a block diagram of the wobble PLL & address detection unit 34 in FIG. 4. The block diagram is mainly divided into 3 blocks of a wobble PLL unit 42, a SYNC/address detection unit 44 and a flywheel counter unit 46. The block diagram shown in FIG. 6 may be constituted by discrete electronic components, but it is preferable for mass production to adopt an integrated circuit (IC) processing (controller LSI).

A wobble signal input to the wobble PLL unit 42 is digitalized by an A-D converter 48. A polarity selection unit 50 inverts the polarity of the input wobble signal to output it or outputs the input wobble signal as it is in accordance with a determination result from a polarity determining unit 56. The output from the selection unit 50 is supplied to a phase detection unit 52. The phase detection unit 52 performs integral calculation for each wobble between the input wobble signal and a reference sine/cosine wave signal to generate a sine/cosine correlation detected value signal. Here, the sine correlation detected value signal is treated in a manner that an inverted phase wobble part (IPW part) is output as “−” value and a normal phase wobble part (NPW part) is output as “+” value.

The sine correlation detected value signal is supplied to the detection unit 44, and a SYNC pattern and an address pattern are detected. The sine correlation detected value signal is also supplied to a phase control unit 54 and the polarity determining unit 56.

The cosine correlation detected value signal is supplied to the phase control unit 54. The cosine correlation detected value signal is used for PLL pull-in as a phase error signal to generate a single clock following the phase with respect to the input signal (wobble signal) from the correlation detected value signal. The phase control unit 54 uses the sine correlation detected value signal to perform preceding value holding, muting, etc., to suppress influence of a code spot (mask IPW part), and conducts loop compensation to adjust a necessary control band and a control gain. Outputting from the phase control unit 54 is feedback to a VCO 60 via a D-A converter 58 to configure a PLL, and the VCO 60 generates a clock of which the phase is matched with that of the wobble signal to supply it to the A-D converter 48.

The sine correlation detected value signal from the phase detection unit 52 and the wobble signal from the polarity selection unit 50 are supplied to the polarity determining unit 56. The polarity determining unit 56 performs the integral calculation for each wobble between a reference sine wave signal of which the phase is shifted by a half wobble period from a reference sine wave signal used by the phase detection unit 52 and the wobble signal, and determines a magnitude relation between an absolute value of a second sine correlation detected value signal and an absolute value of a first sine correlation detected value signal from the phase detection unit 52. The determination result is supplied to the polarity selection unit 50 and the polarity of the wobble signal is inverted in accordance with the determination result.

The flywheel counter unit 46 includes a WDU period counter 68 to count WDUs in 1 period from the output signal of a SYNC detection circuit 62 of the SYNC/address detection unit 44 and a segment period counter 70 to count segments in 1 period from the output signal of the counter 68. The counter 68 counts up 1 WDU (each 84 Wobbles in SYNC field, Address field, Unity field in FIG. 2 and FIG. 3). The counter 70 counts up 17 WDUs forming 1 WAP. The flywheel counter unit 46 detects a phase changing point of the wobble signal, and determines the polarity of the input signal by comparing the magnitudes of the sine correlation detected values of 2 wobbles ahead of or behind the changing point.

FIG. 7 shows the detail of the polarity determining unit 56. A first sine correlation detected value signal output from the phase detection unit 52 is supplied to a magnitude comparison circuit 82 via an absolute value processing circuit 74 and 2-wave addition circuit 76 in order. The wobble signal output from the selection unit 50 is supplied to a sine correlation detection circuit 72. The detection circuit 72 performs integral calculation for each wobble between a second reference sine wave signal of which the phase is shifted by a half wobble period from a reference sine wave signal used when the phase detection unit 54 has calculated the sine correlation detected value signal and the wobble signal to obtain a second sine correlation detected value signal. The second sine correlation detected value signal is supplied to the magnitude comparison circuit 82 via an absolute value processing circuit 78 and a 2-wave addition circuit 80 in order. A WDU period counted value and a segment period counted value from the flywheel counter unit 46 are supplied to the detection circuit 72, the absolute value processing circuits 74 and 78, and addition circuits 76 and 80. The addition circuits 76 and 80 add sine correlation detected value signals of 2-wobble periods ahead of and behind the phase changing point of the wobble signal.

The SYNC/address detection unit 44 is configured to include a SYNC detection circuit 62, a physical address area head detection circuit 64, and a physical address storage unit 66.

The SYNC detection circuit 62 detects an IPW (6 wobble)+NPW (4 wobble)+IPW (6 wobble) part that is a specific part of a SYNC pattern among 84 Wobbles at the predetermined SYNC pattern position (WAP “0”-th in FIG. 2 and FIG. 3) and detects the physical address following the specific part.

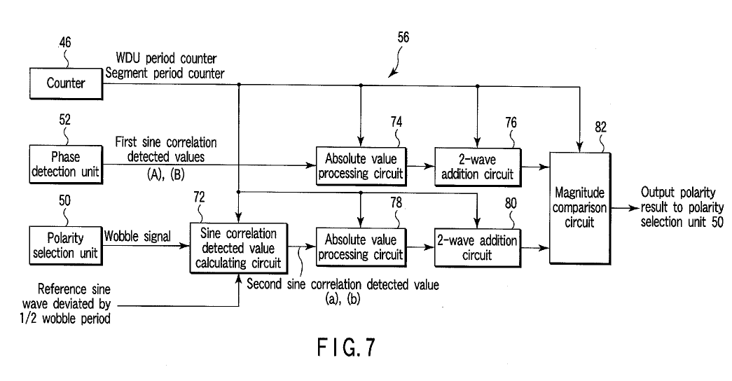

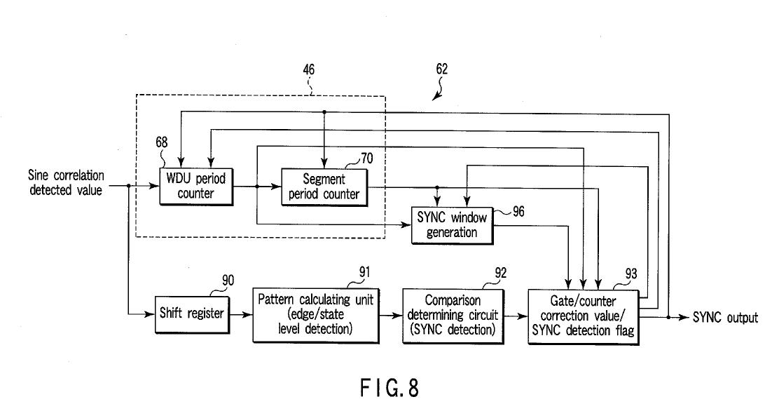

FIG. 8 shows the detail of the SYNC detection circuit 62.

At first, a shift register 90 applies shift processing to the sine correlation detected value signal from the wobble PLL unit 42 (phase detection unit 52). The processing result from the register 90 is input to a pattern calculating unit 91, and the calculating unit 91 performs difference calculation of a code changing point of the sift-processed signal (IPWNPW/NPWIPW: edge detection), and performs detection of the stability of a state (code coincidence) by comparing codes of signals with one another at a point other than the edge changing point. When the edge detected value by the pattern calculating unit 91 is larger than a threshold, and also when it is determined that the state coincides with the SYNC, a comparison determining unit 92 determines that a synchronous signal has been detected and outputs a detected signal.

A SYNC window generation unit 96 uses a WDU period counter 68 to count up 1 WDU (each 84 wobble in SYNC field, Physical Address field and Unity field in FIG. 2 and FIG. 3), and uses the segment period counter 70 to count up 17 WDUs consisting of 1 WAP. The SYNC window generation unit 96 generates a SYNC detection window (gate) signal on the basis of the outputs from the counters 68 and 70.

FIG. 9 shows an example of a block diagram of the physical address area head detection unit 64. As shown in FIG. 2 and FIG. 3, since the physical address field starts just behind the SYNC field, a correct physical address can be detected only after the SYNC detection.

Therefore, the SYNC output which has been output from the SYNC detection unit 62 turns on a flag indicating the fact of the execution of the SYNC detection. When the flag indicating the fact of the SYNC detection is turned on, the head detection unit 64 detects physical address.

In other words, in the circuit configuration in FIG. 9, the head detection unit 64 inputs the SYNC output from the SYNC detection unit 62 to a counter/comparison & enable generation unit 101 to turn on the flag indicating the fact of the execution of the SYNC detection. If the flag is active (=“1”), the head detection unit 64 drives an address head detection window generation unit 102 generating an address head detection window on the basis of the outputs from the WDU period counter 68 and the segment period counter 70 counting the sine correlation detected value signal.

Meanwhile, like the circuit configuration of the SYNC detection unit 62, the head detection unit 64 processes the sine correlation detected value signal by means of the shift register 103 and the pattern calculating unit 104. The head detection unit 64 then performs difference calculation of the code changing points (IPWNPW/NPWIPW: edge detection) of the shift-processed signals, and performs stability (code coincidence) detection of a state by code-comparing signals at other than the edge changing point.

When the flag indicating the execution of the SYNC detection indicates “1”, and if it can be determined that the edge detected value by the pattern calculating unit 104 is larger than a threshold and its state coincides with the address head (for example, sine correlation detected value signal is “- - -”), the comparison determining unit 105 outputs a synchronous signal (SYNC) and a signal showing a physical address position (area).

The synchronous signal (SYNC) output from a comparison & determining unit 105 and the signal showing the physical address position (area) are input as signals to detect the address area head position to the physical address storage unit 107 in a generation period of an address head detection window through the gate/counter & correction value generation unit 106.

If a signal showing the physical address position (area) is generated from the determining unit 105 in a period in which the address head detection window is closed, the signal is not passed though the gate/counter & correction value generation unit 106 by being determined that the signal has erroneously detected.

When receiving the signal showing the physical address position (area), the physical address storage unit 107 takes in and stores the sine correlation detected value signal just after the reception of the signal as physical address information. The address information (address bit 2-bit 0 of 3 bits) stored as given above becomes a physical address output.

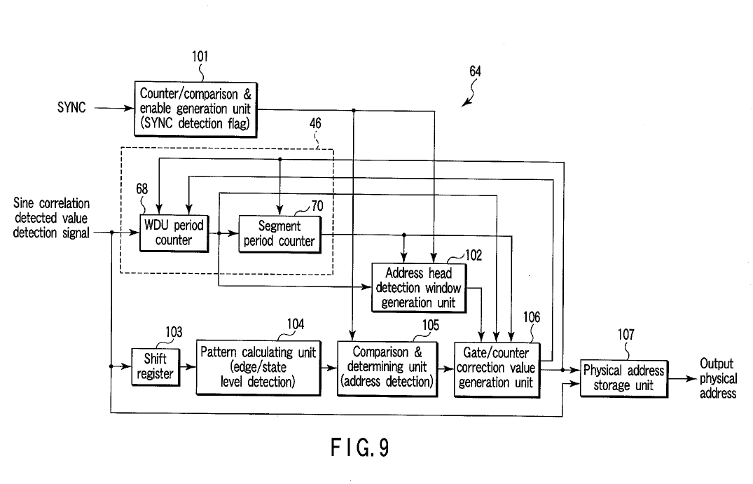

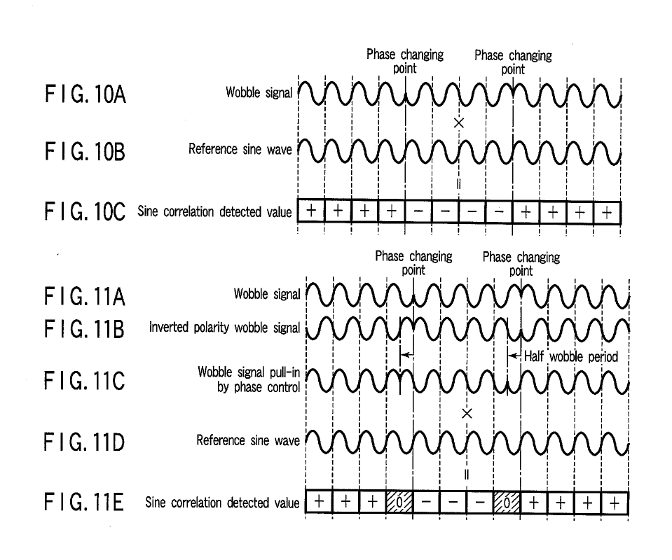

Operations of the wobble PLL & address detection unit 34 in the embodiment with the configuration given above will be described. The concept of sine correlation detected value calculation will be firstly described. FIG. 10 and FIG. 11 show the concept of the sine correlation detected value calculation in the case without and with phase deviation, respectively.

The wobble PLL & address detection unit 34 conducts control by using a sine correlation detected value, which detects a phase correlation degree to a reference sine wave, as a phase error signal. Since the operation of the PLL is, as shown in FIG. 2 and FIG. 3, performed phase tracking on the basis of a non-modulation wave (NPW) comprising a large percentage of the whole of the WAP, the PLL operation is controlled so as not to be affected by the modulation wave (IPW) of the code part. At the code part, the preceding value holding and the muting are conducted, and a tracking time-constant of the PLL is set to a long value so as not to respond to the code part, then, the wobble PLL & address detection unit 34 generates a clock of a basic phase not so much affected by the modulation wave (IPW). In other words, because the wobble signal shown in FIG. 10A and the reference sine wave signal shown in FIG. 10B are applied integral calculation for each wobble to obtain the sine correlation detected value signal, since the wobble signal of the NPW has the same phase as that of the reference sine wave signal, the correlation value becomes the “+” value, and since the wobble signal of the IPW has inverted phase in comparison to the reference sine wave signal, the correlation value becomes the “−” value.

However, even when the wobble signal with inverted polarity as depicted in FIG. 11B (FIG. 11A depicts correct wobble signal), as depicted in FIG. 11C, pilling-in is performed at the position at which the inverted wobble signal deviating by a half wobble period (here, the case of deviation in advance is shown, but deviation is generated in back sometimes). In this case, the sine correlation detected value (integration value of reference sine wave and wobble signal for each wobble) used for the code detection is affected. The sine correlation detected value based on the wobble signal input with the normal polarity as shown in FIG. 10C is output as “+” value on the non-modulation wave (NPW), and as “−” value on the modulation wave (IPW) of the code part. Performing the integral calculation for each wobble between the wobble signal shown in FIG. 11C and the reference sine wave signal shown in FIG. 11D positions the phase changing point at the center of 1 wobble of the wobble including a phase changing point deviated by ½ wobble period as shown in FIG. 11E, so that the sine correlation detected value becomes “0” value, not “+” value and also not “−” value. The correlation detected value of “0” value affects on the detection precision of the SYNC detection and the physical address detection. Since the polarity of the wobble signal varies depending on the specification of the pickup head reading the optical disk, and a track position based on the land/group of the optical disk, it is necessary to confirm the polarity every time.

Therefore, it is necessary to solve such problem given above. The polarity determining unit 56 depicted in FIG. 6 may determine the state in which the wobble signal deviating in phase to be PLL locked. The determining unit 56 detects the phase changing point of the wobble signal from the flywheel counter unit 46 being in synchronization with the wobble signal to determine whether or not the changing point deviates in phase by comparing between two wobble period sine correlation detected values possible to be pull in by means of the PLL pull-in state.

The determining unit 56 performs processing for acquiring absolute values of the first sine correlation detected value signal generated from the input wobble signal and the second sine correlation detected value signal generated while shifting the reference sine wave by a half wobble period in two wobble periods ahead of and behind the phase changing point detected from a counted value from the flywheel counter unit 46 and determines the magnitude of the result of addition of the absolute values to determines the polarities thereof. As for a determining method other than the method of comparing the magnitudes between the results of absolute value processing and two-wave addition, a method of setting a certain threshold (fixed value, or automatically generated value in response to signal level) to compare the sine correlation detected value to the threshold and determining the polarities is a possible approach. To improve the precision of the determining result, it is considered to be that the determining method does not determine by a result from a comparison only at one time, but determines by a result from comparisons at several times (for example, comparisons several phase changing points during 1 WAP, or comparison of one time at the same position (head of SYNC) for each 1 WAP).

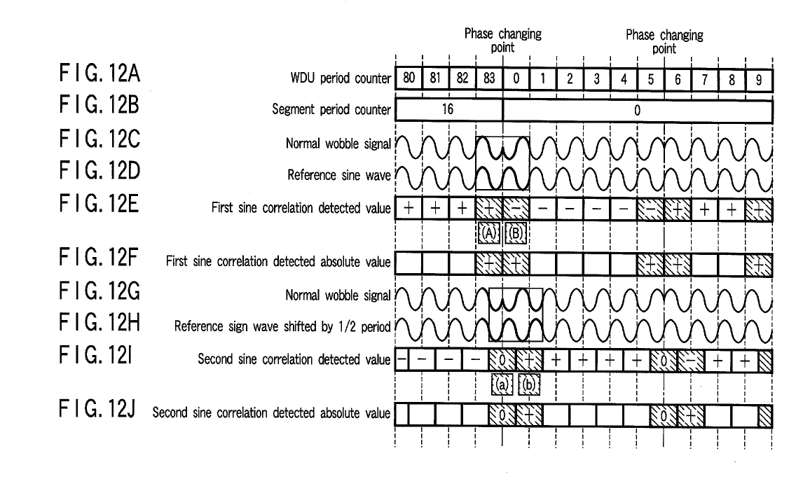

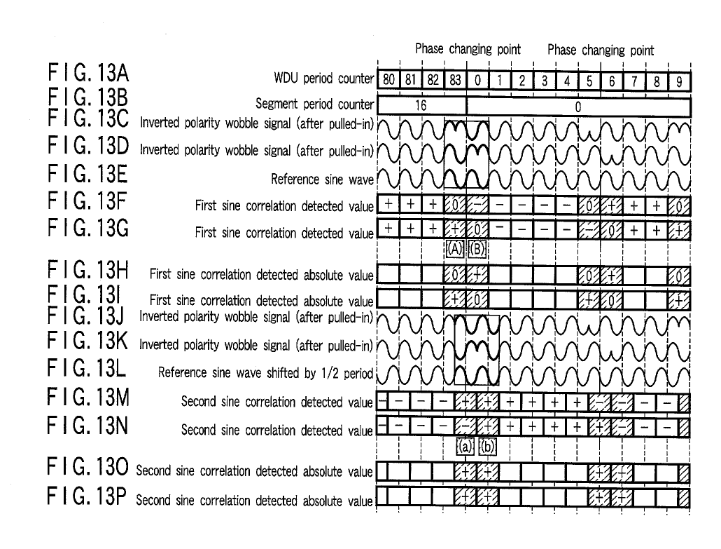

Timing charts to determine the polarities at the head of the SYNC part (head of WAP and WDU 0) of the HD DVD-R/-RAM as examples of the determining points are shown in FIGS. 12A to 12J and FIGS. 13A to 13P. FIGS. 12A to 12J show timing charts in the case in which a correct (with normal polarity) wobble signal is input, and FIGS. 13A to 13P show timing charts in the case in which an incorrect wobble signal (with an inverted polarity) is input.

FIGS. 12A and 12B show counted values of the WDU period counter 68 and the segment period counter 70, respectively. When performing integral calculation between the wobble signal with a normal polarity shown in FIG. 12C and the reference sine wave signal shown in FIG. 12D for each wobble, since the wobble signal (WDU period counter=83) of the NPW has the same phase as that of the reference sine wave signal as is shown in FIGS. 10A to 10C, a correlation value “A” becomes “+” value, and since the wobble signal (WDU period counter 68=0) of the IPW has an inverted phase to the reference sine wave signal, a correlation value “B” becomes “−” value. FIG. 12F shows an absolute value of the first sine correlation detected value. “+” value and “−” value indicate numerical values of almost the same as each other and other than “0” value.

The sine correlation value detection circuit 72 performs integral calculation between the wobble signal having a normal polarity depicted in FIG. 12G and the reference sine wave signal generated while shifting by a half wobble period depicted in FIG. 12H in wobble units to output the second sine correlation detected value signal. As to the second sine correlation detected value signal (FIG. 12I), a correlation value “a” becomes “0” in a wobble period (WDU period counter 68=83 to 0) including a phase changing point, and since the wobble signal (WDU period counter 68=0 to 1) of the NPW has the same phase as that of the reference sine wave signal, a correlation value “b” becomes “+” value. FIG. 12J shows an absolute value of the second correlation detected value signal.

Adding the absolute of the correlation detected values in the 2 wobble periods ahead of and behind the phase changing point, increases the size of the first correlation detected value signal up to “+” value by 2, and makes the second correlation detected value signal to “+” value. Therefore, if the wobble signal with a normal polarity is input, the size of the first sine correlation detected value becomes larger than that of the second sine correlation detected value.

FIGS. 13A to 13P illustrate the case in which the wobble signal with an inverted polarity is input, and FIGS. 13C and 13D illustrate examples in which the PLL perform the pull-in at the position at which the wobble signals are shifted forward by a half wobble period and at the position at which the wobble signal is shifted backward by a half wobble period, respectively. FIGS. 13F and 13G show the first correlation detected value signals between the 2 wobble signals of which the phases are shifted as shown in FIGS. 13C and 13D and the reference sine wave signal shown in FIG. 13E, respectively. In other words, the first correlation detected value signal becomes “0” in a period including a phase changing point, and becomes “+” value or “−” value in a period other than such a period. FIGS. 13H and 13I illustrate the absolute values of the first sine correlation detected values shown in FIGS. 13F and 13G.

The sine correlation detection circuit 72 performs integral calculation in wobble units between the two wobble signals of which the phases are sifted forward and backward due to the PLL pull-in shown in FIGS. 13C and 13D (FIGS. 13J and 13K) and the reference sine wave signal of which the phase is sifted by a half wobble period shown in FIG. 131 to output the second sine correlation detected wave signals as shown in FIGS. 13M and 13N. In this case, since the reference sine wave signal also deviates by a half wobble period, and since the phase changing points surely coincide with 0 degree and 360 degrees of the reference sine wave, the second sine correlation detected value signal does not become “0.” but it surely becomes either “+” value or “−” value. FIGS. 130 and 13P illustrate the absolute values of the second sine correlation detected values.

When adding the absolute values of the correlation detected values on 2 wobble periods ahead of and behind the phase changing point, the absolute value of the first sine correlation detected value signal becomes “+” value, and the absolute value of the second sine correlation detected value signal becomes “+” value having the size of 2 times. Therefore, in the case of input of the wobble signal with the inverted polarity, the size of the second sine correlation detected value signal becomes larger than that of the first sine correlation detected value signal.

According to the results mentioned above, it may be determined that in the case in which the size of the first sine correlation detected value signal is larger than that of the second sine correlation detected value signal, the wobble signal with the normal polarity is input, and in the case in which the size of the second sine correlation detected value signal is larger than that of the first sine correlation detected value signal, the wobble signal with the inverted polarity is input, then, the determination results are supplied to the polarity selection unit 50. If the polarity of the input wobble signal has the inverted polarity, inverting the signal polarity by means of the selection unit 50 enables the signal polarity to be a correct polarity. Thereby, the wobble signal having the correct polarity is input to the PLL unit 42, a PLL lock state without phase deviation is generated, and then, it has made possible for correct SYNC detection and physical address detection to be performed. To improve the detection precision, it is also suitable to correct the polarity when the identical results have been obtained at several times without correcting the polarity on the basis of the one-time determination result.

As to the determining method of a polarity, it is suitable to set a certain threshold (fixed value or automatically generated value corresponding to signal level) other than to perform the magnitude comparison of the foregoing result of absolute value processing and 2-wave addition, and to determine whether the polarity of the wobble signal is normal one or inverted one on the basis whether or not the absolute values of the first and the second sine correlation detected values each exceed the threshold. That is, it may be determined that if the first sine correlation detected value exceeds the threshold, the wobble signal with the normal polarity has been input, and that if the second sine correlation detected value exceeds the threshold, the wobble signal with the inverted polarity has been input.

As described above, according to the first embodiment, it may be determined that whether the wobble signal with the normal polarity has been input or the wobble signal with the inverted polarity has been input in response to the magnitude relation between the first correlation value of the wobble signal and the reference sine wave and the second correlation value of the wobble signal and the reference sine wave deviating by a half period. If the polarity of the input wobble signal is the inversed polarity, the wobble signal with the correct polarity is always input to the PLL by inverting the signal polarity of the wobble signal, and a PLL lock state having no phase deviation is achieved, and this situation has made it possible to perform correct SYNC detection and physical address detection. Therefore, the polarity of the wobble signal varies sometimes, due to the pickup head specification, the optical disk specification, land/group track of the disk, etc., since the polarity may be automatically detected as mentioned above; there is no need to worry about the possibility of a change in polarity of the wobble signal.

A wobble signal detection circuit detects that a reference signal and a wobble signal are phase-locked in a state in which they are displaced in phase, and accurately detects the wobble signal in detecting the wobble signal after matching the phase of a wobble signal modulated in a phase modulation system to the phase of a reference signal by means of PLL control.

As given above, the present invention makes it possible to determine the polarity of the wobble signal on the basis of the correlation value between the wobble signal and the reference signal, the optical disk device may avoid a mistake in polarity determination in a state that the phase deviates by ½ wobble period and that the phase changing point is included, may correctly determine the polarity in a correct phase, and may conduct the synchronization detection and the physical address detection after correcting the signal polarity to the correct polarity by inverting the signal polarity if its phase is shifted from that of the reference signal.

Since the optical disk device uses the flywheel counter unit, it may recognize the phase changing point, it may detect the phase deviation only by the 2 wobbles ahead of or behind the phase changing point, and may accurately determine the polarity.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A wobble signal detection circuit, comprising:
a phase control unit configured to read a phase-modulated wobble signal from an optical disk and control a phase of the wobble signal to coincide with a phase of a reference signal;
a calculating unit configured to calculate a first correlation value reflecting an integration result between a phase controlled wobble signal, which is controlled by the phase control unit and the reference signal, and a second correlation value reflecting an integration result between the phase controlled wobble signal and a phase-inverted signal of the reference signal; and
a polarity determining unit configured to determine a polarity of the phase controlled wobble signal based at least in part on the first and the second correlation value.

2. The wobble signal detection circuit according to claim 1, further comprising a counter configured to count wobble periods of the phase controlled wobble signal, and wherein the calculating unit is configured to calculate the first and the second correlation values in two wobble periods ahead of and behind a time at which the phase of the phase controlled wobble signal changes.

3. The wobble signal detection circuit according to claim 2, wherein the counter comprises a flywheel counter configured to output a synchronous signal and a signal showing a physical address position, said flywheel counter comprising a first counter configured to count wobble data units and a second counter configured to count physical segments including a plurality of wobble data units.

4. The wobble signal detection circuit according to claim 1, wherein the polarity determining unit is configured to determine whether a polarity of the phase controlled wobble signal is a normal polarity or an inverted polarity based at least in part on a magnitude comparison result of absolute values of the first and the second correlation values, and wherein the wobble signal detection circuit further comprises a phase inversion unit configured to invert the phase of the phase controlled wobble signal when the polarity determining unit detects that the polarity of the phase controlled wobble signal is the inverted polarity.

5. The wobble signal detection circuit according to claim 1, wherein the polarity determining unit is configured to determine whether the polarity of the phase controlled wobble signal is the normal polarity or the inverted polarity based at least in part on whether or not absolute values of the first and the second correlations values exceed a threshold, and wherein the wobble signal detection circuit further comprises a phase inversion unit configured to invert the phase of the phase controlled wobble signal when the polarity determining unit detects that the polarity of the phase controlled wobble signal is the inverted polarity.

6. A wobble signal detection method, comprising:
reading a phase-modulated wobble signal from an optical disk;
controlling a phase of the wobble signal to coincide with a phase of a reference signal;
calculating a first correlation value reflecting an integration result between a phase controlled wobble signal and the reference signal;
calculating a second correlation value reflecting an integration result between the phase controlled wobble signal and a phase-inverted signal of the reference signal; and
determining a polarity of the phase controlled wobble signal based at least in part on the first and the second correlation value.

7. The wobble signal detection method according to claim 6, further comprising:
counting wobble periods of the phase controlled wobble signal; and
calculating the first and the second correlation values in two wobble periods ahead of and behind a time at which the phase of the phase controlled wobble signal changes.

8. The wobble signal detection method according to claim 7, wherein counting the wobble periods comprises using a flywheel counter configured to output a synchronous signal and a signal showing a physical address position, said flywheel counter comprising a first counter configured to count wobble data units and a second counter configured to count physical segments including a plurality of wobble data units.

9. The wobble signal detection method according to claim 6, wherein determining the polarity of the phase controlled wobble signal comprises determining whether the polarity of the phase controlled wobble signal is the normal polarity or the inverted polarity based at least in part on a magnitude comparison result of absolute values of the first and second correlation values, the wobble signal detection method further comprising inverting the phase of the phase controlled wobble signal when it is determined that the polarity of the phase controlled wobble signal is the inverted polarity.

10. The wobble signal detection method according to claim 6, wherein determining the polarity of the phase controlled wobble signal comprises determining whether the polarity of the phase controlled wobble signal is the normal polarity or the inverted polarity based at least in part on whether or not absolute values of the first and the second correlations values exceed a threshold, the wobble signal detection method further comprising inverting the phase of the phase controlled wobble signal when it is determined that the polarity of the phase controlled wobble signal is the inverted polarity.

11. An optical disk device comprising:
an optical pickup head configured to irradiate a laser beam onto an optical disk and receive a reflection laser beam from the optical disk, the optical pickup head comprising a plurality of photo detection cells configured to output a plurality of signals;
an RF (radio frequency) amplifier configured to receive the plurality of signals from the optical pickup head and output a tracking error signal, a focus error signal, a phase-modulated wobble signal, and an RF signal;
a tracking control unit configured to receive the tracking error signal from the RF amplifier and perform a tracking control of the optical head;
a focusing control unit configured to receive the focus error signal from the RF amplifier and perform a focus control of the optical head;
a wobble PLL (phase locked loop) and address detection unit configured to receive the wobble signal; and
a data reproduction unit configured to receive the RF signal from the RF amplifier and perform a data reproduction, wherein the wobble PLL and address detection unit comprises:
a phase control unit configured to read the phase-modulated wobble signal from the RF amplifier and control a phase of the phase-modulated wobble signal to be coinciding with a phase of a reference signal;
a calculating unit configured to calculate a first correlation value reflecting an integration result between a phase controlled wobble signal, which is controlled by the phase control unit and the reference signal, and a second correlation value reflecting an integration result between the phase controlled wobble signal and a phase-inverted signal of the reference signal; and
a polarity determining unit configured to determine a polarity of the phase controlled wobble signal based on the first and the second correlation value.

12. The optical disk device according to claim 11, further comprising a counter configured to count wobble periods of the phase controlled wobble signal, and wherein the calculating unit calculates the first and the second correlation values in two wobble periods ahead of and behind a time at which the phase of the phase controlled wobble signal changes.

13. The optical disk device according to claim 12, wherein the counter comprises a flywheel counter configured to output a synchronous signal and a signal showing a physical address position, the flywheel counter comprising a first counter configured to count wobble data units and a second counter configured to count physical segments including a plurality of wobble data units.

14. The optical disk device according to claim 11, wherein the polarity determining unit is configured to determine whether a polarity of the phase controlled wobble signal is a normal polarity or an inverted polarity based at least in part on a magnitude comparison result of absolute values of the first and the second correlation values, and wherein the wobble signal detection circuit further comprises a phase inversion unit configured to invert the phase of the phase controlled wobble signal when the polarity determining unit detects that the polarity of the phase controlled wobble signal is the inverted polarity.

15. The optical disk device according to claim 11, wherein the polarity determining unit is configured to determine whether the polarity of the phase controlled wobble signal is the normal polarity or the inverted polarity based at least in part on whether or not absolute values of the first and the second correlation values exceed a threshold, and wherein the wobble signal detection circuit further comprises a phase inversion unit configured to invert the phase of the phase controlled wobble signal when the polarity determining unit determines that the polarity of the phase controlled wobble signal is the inverted polarity.
